(19) United States
(12) Patent Application Publication
(10) Pub. No.: US 2025/0304383 A1
(43) Pub. Date: Oct. 2, 2025

(54) SYSTEM FOR HANDLING POWDERED MATERIALS

(71) Applicant: THE CHEMOURS COMPANY FC, LLC, WILMINGTON, DE (US)

(72) Inventors: MASSIH PASHA, HOCKESSIN, DE (US); CHARLES COLLINS, WILMINGTON, DE (US)

(73) Assignee: THE CHEMOURS COMPANY FC, LLC, WILMINGTON, DE (US)

(21) Appl. No.: 18/864,044

(22) PCT Filed: May 9, 2023
(86) PCT No.: PCT/US2023/021483

§ 371 Date: Nov. 8, 2024

Related U.S. Application Data
(60) Provisional application No. 63/340,118, filed on May 10, 2022.

(51) Int. Cl. B65G 53/28; B65D 88/72; B65G 53/26; B65G 53/34; B65G 53/38; B65G 53/40; B65G 53/46; B65G 53/60; B65G 53/66

(52) U.S. Cl. CPC B65G 53/28; B65D 88/72; B65G 53/26; B65G 53/34; B65G 53/38; B65G 53/40; B65G 53/46; B65G 53/60; B65G 53/66; B65G 2812/165; B65G 2812/1658

(57) ABSTRACT

A method for handling polytetrafluoroethylene (PTFE) powder, the method including receiving PTFE powder into a hopper having a conical section; reducing a sticking force (1) between an inner surface of the conical section of the hopper and the PTFE powder, (2) among particles of the PTFE powder, or both; discharging the PTFE powder from an outlet located near a base of the conical section of the hopper into a transfer channel; applying a pressure differential to the transfer channel to convey the PTFE powder in a dilute phase including a gas and the PTFE powder along the transfer channel; and at an outlet of the transfer channel, separating the PTFE powder from the gas, in which the separated PTFE powder has a particle morphology that is sufficient for dry manufacturing of film battery electrodes.

### CROSS REFERENCE TO RELATED APPLICATIONS

This application is a national filing under 35 U.S.C. 371 of International Application No. PCT/US2023/021483 filed May 9, 2023, and claims the benefit of priority of U.S. Provisional Application No. 63/340,118 filed May 10, 2022, the disclosure of which is incorporated herein by reference in its entirety.

### FIELD OF THE DISCLOSURE

The disclosure relates to handling powdered materials and more specifically, to handling fine powders of polymer materials.

### BACKGROUND

Polytetrafluoroethylene (PTFE) is widely used to prepare electrode materials for batteries, fuel cells and supercapacitors. PTFE can be used as a binder of the battery materials, or as an electrospun nanofiber separator. Traditionally, PTFE is manufactured and transported as a powdered material or in a liquid suspension. Increasing demand for batteries has increased the need for transportation, storage, and conveyance of PTFE powders at greater scales. However, PTFE powders are sensitive to fibrillation in which the PTFE particles of the powder undergo morphological changes from a particle morphology to fiber morphology responsive to applied stresses or forces. For instance, PTFE particles can fibrillate under handling and storage conditions that impose stress or friction forces on the particles.

### SUMMARY

Disclosed herein are systems and methods for handling of fine PTFE powders at large scales, including the storage and conveyance of the powders from source to outlet, while maintaining a sufficient amount of the PTFE powder in a substantially unfibrillated state that the PTFE powder is suitable for use in downstream applications, such as for use in dry manufacturing processes for battery electrodes.

In one example, disclosed herein is a method for handling polytetrafluoroethylene (PTFE) powder, the method including receiving PTFE powder into a hopper having a conical section: reducing a sticking force (1) between an inner surface of the conical section of the hopper and the PTFE powder, (2) among particles of the PTFE powder, or both: discharging the PTFE powder from an outlet located near a base of the conical section of the hopper into a transfer channel: applying a pressure differential to the transfer channel to convey the PTFE powder in a dilute phase including a gas and the PTFE powder along the transfer channel: and at an outlet of the transfer channel, separating the PTFE powder from the gas, in which the separated PTFE powder has a particle morphology that is sufficient for dry manufacturing of film battery electrodes.

Examples can include the following features. At least some of the separated PTFE powder can include substantially unfibrillated PTFE agglomerates. The separated PTFE powder can include a sufficient quantity of substantially unfibrillated PTFE agglomerates to enable manufacturing of the film battery electrodes. At least 40% by weight of the PTFE powder received into the hopper can be separated from the gas for use for manufacturing of the film battery electrodes. Receiving the PTFE powder into the hopper can include receiving at least 200 pounds of PTFE powder into the hopper. Receiving the PTFE powder into the hopper can include receiving a volume of PTFE powder that can be less than a threshold volume of PTFE powder, in which the threshold volume of PTFE powder can be a volume of PTFE powder that, when received into the hopper, undergoes aggregation due to a force exerted by its own weight. The method can further include applying a suction to an inlet channel to convey an initial dilute phase can include the PTFE powder along the inlet channel and into the hopper. Receiving the PTFE powder into the hopper can include receiving the PTFE powder from an upstream hopper. PTFE can be transferred from the upstream hopper to the hopper via force of gravity alone. The hopper can include a first hopper and can include discharging PTFE powder from an outlet of a second hopper into the transfer channel. Receiving the PTFE powder into the hopper can include receiving the PTFE powder by direct mechanical transfer of the PTFE powder from a drum containing the PTFE powder. Reducing a sticking force between the inner surface of the hopper and the PTFE powder can include aerating the inner surface of the hopper. Aerating the inner surface of the hopper can include flowing an aeration gas between an outer wall of the conical section of the hopper and a porous inner wall of the conical section of the hopper. The porous inner wall of the conical section can extend from the outlet of the conical section to a position along the inner wall of the conical section where a diameter of the conical section can be at least 75% of a maximum diameter of the conical section. The method can further include cooling the aeration gas prior to flowing of the aeration gas. The aeration gas can include an inert gas. The aeration gas can contain substantially no water.

The method can further include cooling a wall of the conical section of the hopper. Cooling can include cooling the wall of the conical section of the hopper to a temperature below a beta transition temperature of the PTFE powder. The hopper can include a cylindrical section connected to the conical section and can include cooling a wall of the cylindrical section and the wall of the conical section of the hopper. The conical section of the hopper can include a cooling jacket disposed on the wall of the conical section, and in which cooling the wall of the conical section can include flowing a cooling fluid through the cooling jacket. The method can further include providing a layer of cooling gas in the hopper between the PTFE powder and an inlet of the hopper. A height of the hopper can be at least twice as large as a maximum diameter of the conical section of the hopper. An inner surface of the hopper can include stainless steel. The inner surface of the hopper can include a polished stainless steel, in which the polishing can be in a direction of flow of the PTFE powder. Reducing a sticking force between the inner surface of the hopper and the PTFE powder can include applying a mechanical vibration to the PTFE powder in the hopper. Reducing a sticking force between the inner surface of the hopper and the PTFE power can include injecting a gas into the PTFE powder in the hopper. Applying a pressure differential to the transfer channel can include applying a suction to the pressure channel. Applying a pressure differential to the transfer channel can include applying a positive pressure to the pressure channel. Applying a pressure differential to the transfer channel can include applying a pressure differential to generate a pickup velocity of at least 2,500 feet per minute. Applying a pressure differential to the transfer channel can include operating a variable frequency drive to apply the pressure differential to the transfer channel.

The method can further include operating the variable frequency drive to control a velocity of the dilute phase in the transfer channel. The method can further include cooling the transfer channel. The transfer channel can include a jacket, and in which cooling the transfer channel can include flowing a fluid through the jacket of the transfer channel. The method can further include cooling the gas of the dilute phase. The gas of the dilute phase can include an inert gas. An inner surface of the transfer channel can include stainless steel. An inner surface of the transfer channel can be free of weld points. Conveying the dilute phase along the transfer channel can include conveying the dilute phase around an elbow designed to reduce compaction and shear. The method can further include maintaining the gas of the dilute phase at a temperature that can be above a dew point of the environment of the transfer channel. The method can further include separating the PTFE powder from the gas in a cyclone separator. The method can further include applying suction to the cyclone separator. The method can further include separating the PTFE powder from the gas in a bag filter. Separating the PTFE powder from the gas can include separating the PTFE powder from the gas in a separator: and flowing the PTFE powder through a discharge valve at an outlet of the separator. The discharge valve of the separator can include a flapper valve. The method can further include separating the PTFE powder from the gas in multiple separators arranged in series or parallel along the transfer channel. Each of the multiple separators has discharge valves that connect to a common receiving vessel. The method can further include sieving the separated PTFE powder using a sieve to break up or remove clumps of material. The method can further include vibrating the sieve. The sieve can include a mesh with openings 2 mm in diameter.

In a second example, disclosed herein is a PTFE powder product obtained by the method of any of the preceding claims, in which the separated PTFE is the powder product.

In a third example, disclosed herein is a system for handling PTFE, the system including a hopper having a conical section, the hopper containing PTFE powder including substantially unfibrillated PTFE agglomerates, in which the hopper can include a mechanism for reducing a sticking force (1) between an inner surface of the conical section of the hopper and the PTFE powder, (2) among particles of the PTFE powder, or both: a transfer channel, in which the hopper is communicatively coupled with the transfer channel via an outlet defined at a base of the conical section, and in which the transfer channel contains PTFE powder: a flow control device configured to apply a pressure differential to the transfer channel, in which the pressure differential applied to the transfer channel causes conveyance of the PTFE powder in a dilute phase including a gas and the PTFE powder along the transfer channel: and a separator disposed at an outlet of the transfer channel and configured to separate the PTFE powder from the gas, in which the separated PTFE powder has a particle morphology that is sufficient for dry manufacturing of film battery electrodes.

Examples can include one or more of the following features. The hopper can contain at least 200 pounds of PTFE powder. The mechanism for reducing the sticking force can include a porous sheet. The porous sheet can extend along the inner wall of the conical section from the outlet of the conical section to a position along the inner wall of the conical section where a diameter of the conical section can be at least 75% of a maximum diameter of the conical section. The mechanism for reducing the sticking force can include a bin activator. The mechanism for reducing the sticking force can include an air injector. The system can further include a cooling jacket disposed on a wall of the conical section. A height of the hopper can be at least twice as large as a maximum diameter of the conical section of the hopper. An inner surface of the hopper can include stainless steel. The inner surface of the hopper can include a polished stainless steel, in which the polishing can be in a direction of flow of the PTFE powder. The flow control device can include a suction source. The flow control device can include a positive pressure flow device. The flow control device can include a variable frequency drive. The transfer channel can include a cooling jacket. An inner surface of the transfer channel can include stainless steel. An inner surface of the transfer channel can be free of weld points. The transfer channel can include an elbow designed to reduce compaction and shear. The separator can include a cyclone separator. The separator can include a bag filter. The separator can include a flapper valve. The system can further include a sieve positioned to receive the separated PTFE powder from the separator. The system can further include multiple hoppers connected in series. The system can further include multiple hoppers connected in parallel, in which each hopper can be communicatively coupled with the transfer channel via a respectively outlet.

Particular implementations of the subject matter described in this specification can be implemented so as to realize one or more of the following technical advantages.

The approaches described here enable large quantities (e.g., at least 200 pounds) of fine PTFE powder to be processed (e.g., stored and conveyed) in bulk, with at least some of the input PTFE powder being recoverable at the output of the system in substantially unfibrillated form. The unfibrillated PTFE powder recovered from the systems and methods described here is usable for compounding with other components in a dry battery manufacturing process.

The details of one or more embodiments are set forth in the accompanying drawings and the description below. Other features and advantages will be apparent from the description and drawings, and from the claims.

### DESCRIPTION OF DRAWINGS

FIG. 1 is a schematic diagram illustrating a powder handling system for handling of fine PTFE powders.

FIG. 1B is a cross-sectional diagram of a storage unit for the powder handling system.

FIGS. 2A-2C are cross-sectional diagrams of several examples of active zones for the storage unit of the powder handling system.

FIG. 3 is a series of depictions of outlets for the storage unit of the powder handling system.

FIGS. 4A and 4B are schematic illustrations of example separators for the powder handling system 100.

FIG. 5 is a flow chart diagram illustrating the steps of a method for handling fine PTFE powders.

In the figures, like references indicate like elements.

### DETAILED DESCRIPTION

Fine powders of PTFE include individual PTFE aggregates that themselves include compacted subunits of PTFE particles. Fine PTFE powders are sensitive to fibrillation that can be induced, e.g., by shear forces applied to the powders during transportation, conveyance, or storage of the powders. Fibrillation is an irreversible process in which the particles undergo polymeric unwinding and mechanical interlocking often resulting in agglomeration of individual particles and leading to the formation of lumps and aggregated materials. Fibrillated PTFE is often not suitable for downstream processes. For instance, PTFE powders that have been fibrillated are generally unsuitable for use in dry battery electrode manufacturing processes. Description of fibrillation of PTFE powders can be found in Ebnesajjad et al, (2015) Fluoroplastics (Second Edition), 1:11, 234-277, the contents of which are incorporated here by reference in their entirety.

This disclosure describes storage and handling methods for large volumes of fine PTFE powder, including active aeration of a section of a storage hopper to reduce sticking forces, e.g., friction and/or shear, between the inner surfaces of the storage hoppers reduce bulk aggregation and/or compaction of the PTFE powders. Conveying methods which reduce shear imparted to the PTFE powder and maintain the temperature of the powder below standard environmental temperatures facilitate maintaining flow characteristics and reducing bulk aggregation in the output material. These approaches enable bulk handling of large volumes of PTFE powder while obtaining, as an output, substantially unfibrillated PTFE agglomerates that have a quality (e.g., particle morphology) sufficient to enable dry manufacturing of film battery electrodes. A significant amount of the input PTFE powder is recoverable at the output as substantially unfibrillated PTFE suitable for use in battery manufacturing applications. For instance, at least 200 pounds of fine PTFE powder can be provided as a bulk input and stored and conveyed using these approaches, with at least 40%, at least 50%, or at least 60% by weight of the input PTFE powder recovered as output PTFE powder.

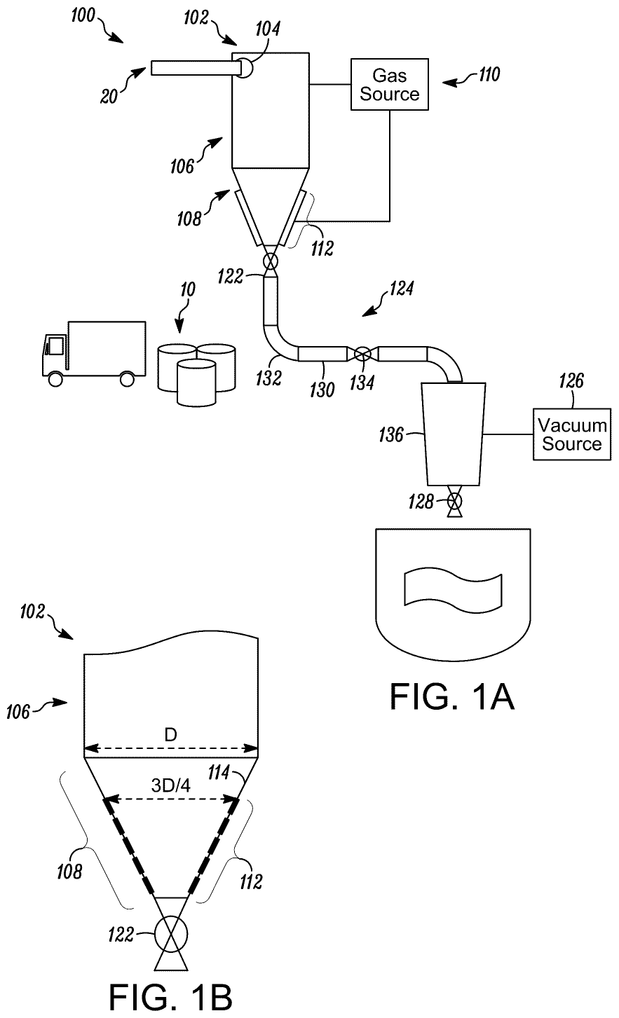

FIG. 1 is an example PTFE powder handling system 100 which reduces shear and compaction of large quantities of bulk PTFE powders. The system 100 receives bulk PTFE powder in a free-flowing, non-compacted form from one or more sources. In one example, the bulk PTFE powder is received from discrete sources, such as barrels 10 or totes. Alternatively, or in addition, the bulk PTFE powder is received from continuous sources, such as conveyors 20, or upstream manufacturing processes.

The components of the powder handling system 100 are manufactured from rigid, durable materials and constructed to have contact surfaces of low roughness, e.g., polished surfaces. As one example, the components of the system 100 are manufactured from stainless steel or include contact surfaces manufactured from stainless steel. The contact surfaces of the components have surface finish of 2B or better (e.g., 2G, 2R, 2J) according to the EN 10088-2 standard (e.g., a surface roughness of 0.5 μm or less). The contact surfaces of the components can be polished in a direction that is aligned with an expected direction of flow of the PTFE powder through the system.

The system 100 receives the bulk PTFE powders into a storage unit 102, such as a hopper. In the example of FIG. 1, the powder handling system 100 includes one storage unit 102 through in some implementations, a powder handling system 100 includes two or more storage units 102 connected in series (e.g., the output of one storage unit is fed into the next storage unit in the series) or in parallel (e.g., the output of each storage unit is fed into the same destination). The storage unit 102 defines an inner volume of sufficient size to contain large quantities of PTFE powder. For example, the storage unit 102 is sized to receive more than 100 lbs of PTFE powder (e.g., more than 200 lbs, more than 500 lbs, or more than 1000 lbs). In some examples, the amount of PTFE powder that can be stored in the storage unit 102 is limited by the weight of the PTFE powder, e.g., the amount of PTFE powder is limited to an amount that does not undergo aggregation, fibrillation, or both, due to a force exerted by the weight of the PTFE powder itself.

The storage unit 102 receives the PTFE powders through an inlet 104 which connects the interior volume of the storage unit 102 to the external environment. The inlet 104 is reversibly sealable, e.g., using threaded screw connections, hinges, flanges, or clamps, such that the inlet 104 seals the inner volume against fluid, gaseous, or material flow when sealed. The inlet 104 is sized and arranged to receive PTFE powders. The storage unit 102 is generally arranged such that PTFE powders received through the inlet 104 flow under gravity through the upper section 106 to the lower section 108 of the storage unit 102. The inlet 104 is sized and arranged to receive PTFE powders into the upper section 106 of the storage unit 102 through mechanisms including conveyors, buckets, manual loading, or automated loading.

The storage unit 102 of the example system 100 has a cylindrical upper section 106 and a conical lower section 108, both having circular cross sections, although other cross sections can be utilized. The height of the upper section is larger than a transverse dimension (e.g., a diameter) of the conical lower section 108, e.g., at least twice as large.

In some implementations, the storage unit 102 is cooled below ambient temperature to reduce the handling temperature of the received PTFE powder. For example, the storage unit 102 includes a gas-or liquid-based temperature control system which functions to maintain the inner volume and materials stored therein at a temperature that is lower than ambient temperature (e.g., <25° C.). Operation at reduced temperature reduces shear on the PTFE powder, thereby helping to avoid fibrillation.

An example of a storage unit 102 including a gas- or liquid-based temperature control system is a hopper including a cooling jacket disposed around all or a portion of the outer wall of the storage unit 102 (e.g., an outer wall of the upper section 106, an outer wall of the lower section 108, or both), in which a cold liquid is circulated through the cooling jacket. The storage unit 102 be temperature controlled (e.g., can include the temperature control system) over the entire outer surface of the storage unit 102, or a portion of the storage unit 102, e.g., the upper section 106, the lower section 108, or both. In some examples, the storage unit 102 is temperature controlled to a temperature below a beta transition temperature of the PTFE powder (e.g., at or below 20° C., at or below 19° C., at or below 15° C., at or below 12° C., at or below 10° C., at or below 5° C.) and above a dew point of the environment.

Generally, storage and handling of PTFE powders at reduced temperatures decreases the occurrence of bulk aggregation and fibrillation of PTFE. Storing and handling the PTFE powders at temperatures at or below the beta transition temperature reduces the occurrence of bulk aggregation.

Here and throughout the specification, reference to a measurable value such as an amount, a temporal duration, and the like, the recitation of the value encompasses the precise value, approximately the value, and within ±10% of the value. For example, in this specification, reference to a temperature of 15° C. encompasses precisely 15° C., approximately 15° C., and within ±10% of 15° C.

The powder handling system 100 includes or is connected to a gas source 110 which provides a source of pressurized gas to the components of the powder handling system 100 including the storage unit 102. Examples of the gas source 110 include static sources, such as cylinders, or tanks, or continuous, on-demand sources such as compressors. The gas source 110 can include filters to supply substantially pure (e.g., 99.99% pure or greater) gas to the powder handling system 100. In some implementations, the gas source 110 supplies 99.999% pure gas to the powder handling system 100. The gas source 110 supplies dry gas to the powder handling system 100 having a dew point (e.g., the temperature the air needs to be cooled to at constant pressure in order to achieve a relative humidity (RH) of 100%) of less than 15° C. (e.g., less than 10° C., less than 8° C.). Supplying dry gas to the powder handling system 100, and maintaining the temperature above the dew point, reduces the occurrence of condensation during handling of PTFE powders, which can be important for downstream processing, such as dry battery manufacturing processes.

The gas supplied by the gas source 110 to the storage unit 102 is non-reactive, e.g., inert, to reduce contamination of the PTFE powders with reaction materials, such as oxidative reaction products. The gas supplied by the gas source 110 is cooled to a temperature below atmospheric temperature, e.g., <25° C. In some implementations, the gas source 110 supplies the gas to the upper section 106 of the storage unit 102. Supplying a cool, dry, inert gas to the upper section 106 of the storage unit 102 displaces atmospheric gases from the inner volume of the storage unit 102 reducing aggregation due to thermal and chemically reactive effects.

In some implementations, the gas source 110 supplies pressurized gas to the lower section 108 of the storage unit 102. The gas received by the lower section 108 is applied to the inner volume of the storage unit 102 in an area termed an “active zone.” FIG. 1B is a cross sectional view of the inner volume of the lower section 108 and a portion of the upper section 106. The active zone 112 is an area of the lower section 108 which includes mechanisms to reduce sticking forces such as friction or shear between the inner surfaces 114 of the storage unit 102 contacting the PTFE powder, reduce inter-particle friction within the PTFE powder itself, or both. The active zone 112 fluidizes a portion of the fine PTFE powder contacting or near the inner surfaces 114 to start and maintain flow out of the storage unit 102. In some examples, gas is not supplied to the active zone 112 and mechanisms to reduce sticking forces are employed that do not use gas.

The active zone 112 includes all or a portion of the total surface area of the lower section 108. In an example, the upper section 106 of the storage unit 102 shown in FIG. 1B has a greatest dimension, e.g., diameter, of D. The active zone 112 of the lower section 108 extends from the lowest point of the lower section 108 to a height corresponding with ¾ D. In general, the active zone 112 can extend over the entire lower section 108 (e.g., to a height corresponding with 1 D). ¾ D is generally sufficient to reduce friction between the inner surfaces 114 and the PTFE powder and maintain flow of the contents of the storage unit 102 when the outlet 122 is open.

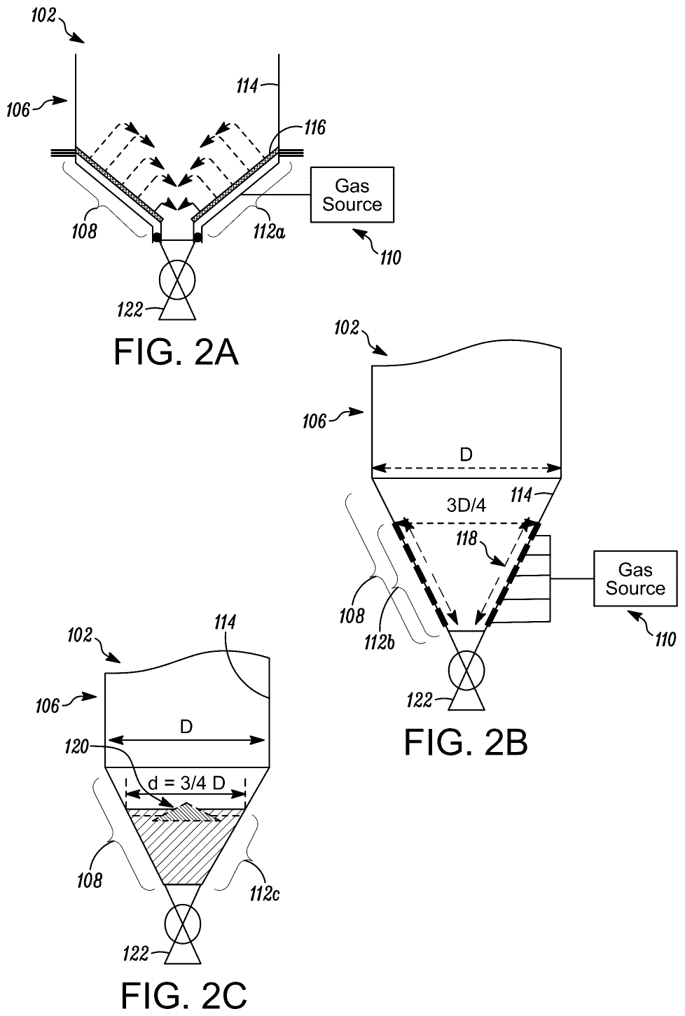

Referring now to FIGS. 2A-2C, examples of active zone 112 are shown, including active zones 112a, 112b, and 112c. In FIG. 2A, the storage unit 102 includes an active zone 112a which includes a porous inner wall 116. The pores are sized to be permissive to gaseous flow but restrict flow of the PTFE powder through the porous inner wall 116, thereby enabling aeration of the inner wall 116. In one example, the porous inner wall 116 is manufactured from sintered metallic material, see for example Dynapore® porous metal laminates manufactured by Parker Hannifin (Cleveland, OH, USA). In another example, the porous inner wall 116 is composed of a filter material, such as cloth, e.g., a PTFE coated polyester woven media such as a BTS discharge bottom manufactured by Zeppelin Systems (Garching, DE). In another example, the porous inner wall 116 of the active zone 112a includes uniformly distanced aeration holes, such as SIPERM® aeration inserts manufactured by Tridelta Siperm (Dortmund, DE). In another example, the active zone 112c includes aeration pads, e.g., multilayer wire mesh with finished contact surface that produces a smooth evenly distributed airflow, such as TransFlow® Powder Fluidization Pads manufactured by Young Industries (Muncy, PA, USA).

In FIG. 2B, the active zone 112b is a region of the lower section 108 which includes an array of gas ports 118. The gas source 110 supplies pressurized gas to the discrete gas ports 118 that provide localized injection of gas at discrete points along the inner surfaces 114 of the lower section 108, thereby aerating the inner surfaces 114. Localized injection of gas can be provided, e.g., using Airsweep® technology or Solimar® technology. Aerated active zones, such as active zone 112a or active zone 112b, promote fluidization over a substantially uniform distribution across the inner surfaces 114 of the lower section 108.

In FIG. 2C, the active zone 112c includes an inverted vibratory cone 120 in the lower section 108. The vibratory cone 120 is powered to generate vibrations along the surfaces of the vibratory cone 120. The vibrations transmit energy into the surrounding PTFE powder according to the frequency and energy of the generated vibrations and fluidize the surrounding PTFE powder by decreasing surface friction between the vibratory cone 120 and the PTFE powder and inter-particle friction. For example, see bin activators manufactured by Vibra Screw (Totowa, NJ, USA). In the example of FIG. 2C, the greatest dimension of the active zone 112c is ¾ D or greater. The vibratory active zone 112c induces more shear and compaction than actives zones 112 utilizing gas flow to fluidize the PTFE powder, such as example active zones 112a and 112b. The vibratory active zone 112c is an example of an active zone that does not rely on a gas supply.

In some examples, when the system 100 includes multiple storage units 102, only some of the storage units 102 are equipped with an active zone 112. For instance, an initial storage unit can be configured such that PTFE powder flows from the initial storage unit to a subsequent storage unit by force of gravity alone, and the subsequent storage unit is equipped with an active zone 112.

Referring again to FIG. 1, the storage unit 102 is connected to an outlet 122 at a base of the lower section 108. The outlet 122 operates to gate the flow of PTFE powder from the storage unit 102. When the outlet 122 is in a flow-permissive state (e.g., at least partially open), the PTFE is discharged from the storage unit 102. When the outlet 122 enters a flow-restrictive state (e.g., a closed state), the outlet 122 ceases the discharge of PTFE powder from the storage unit 102. In some implementations, a system controller operates the active zone 112 and the outlet 122 in an interlock-type manner such that when the outlet 122 is in a flow-permissive state, the active zone 112 fluidizes the PTFE powder in the lower section 108. When the outlet 122 enters a flow-restrictive state, the active zone 112 ceases to fluidize the PTFE powder in the lower section 108. Such operation reduces shear applied to the PTFE powder during storage and increases flow rates from the storage unit 102 during discharge. In some examples, the outlet 122 is configured to permit an average PTFE powder flow rate of 100 lbs/hr. In other examples, the outlet 122 is configured to permit 1000 lbs/hr or more.

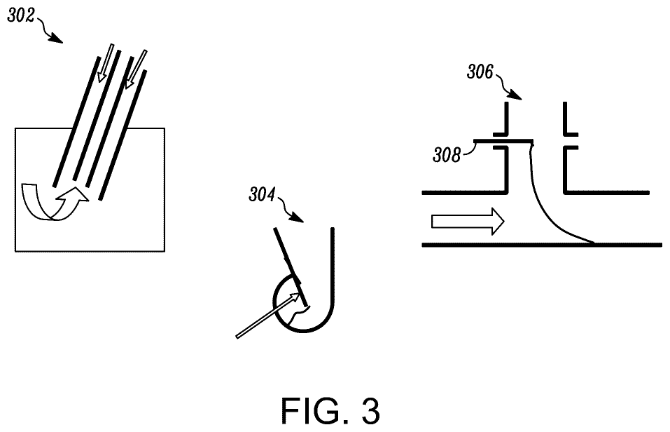

Referring to FIG. 3, examples of outlets which can be used for the outlet 122 are shown. A pick-up wand 302 entrains PTFE powder in a carrier gas by flowing carrier gas along a central channel. A negative pressure is applied to the central channel such that as the flowing carrier gas entrains PTFE powder thereby inducing the PTFE powder into a dilute phase, the dilute phase PTFE powder is directed into the central channel and to downstream components. In some examples, the pick-up wand 302 draws PTFE powder from the storage unit 102 in the upper section 106. The pick-up wand 302 is utilized if the storage unit 102, e.g., hopper, is configured to draw the material from the top, e.g., from the upper section 106.

A baffle outlet 304 receives PTFE powder which causes the powder to take the material angle of repose. This increases the overall material surface area for flowing carrier gas to entrain the PTFE powder and induce the dilute phase of the powder.

A slide gate outlet 306 restricts the PTFE powder feed rate with a slideable gate 308. The gate 308 is continuously slideable between an open state and a closed state which regulates the feed rate while a flap connected to the gate 308 directs flowing PTFE powder to an outlet.

The examples of FIG. 3 are non-limiting. The examples shown can be used alone, or in combination with described examples, or other examples which permit PTFE powder to flow from the storage unit 102 with relatively low shear and under a pressure differential.

Referring again to FIG. 1, the outlet 122 is in fluid connection with a transfer channel 124. The PTFE powder discharged from the outlet 122 enters the transfer channel 124 and is conveyed in a dilute phase downstream away from the storage unit 102. In some implementations, the transfer channel 124 is angled downward such that the PTFE is conveyed through the transfer channel 124 at least partially by gravity. Additionally, or alternatively, a portion of the transfer channel 124 is substantially planar and does not include elevation changes through the planar portion. In some implementations, the transfer channel 124 is connected to a pressure differential-generating system. The pressure differential can be a positive pressure differential or a negative pressure differential (e.g., a suction). The pressure differential flows the carrier gas through the transfer channel 124 which causes the PTFE powder to enter a dilute phase while being conveyed through the transfer channel 124.

In dilute phase systems, the PTFE powder particles are uniformly suspended in a carrier gas. In one example, the pressure-generating system is a positive-pressure system (e.g., a blower). Additionally, or alternatively, the pressure-generating system is a negative-pressure system (e.g., vacuum source 126). A variable frequency drive can be used to control the gas flow rate (and consequently the pressure differential) and thus the velocity of the PTFE powder dilute phase being conveyed through the transfer channel 124. In general, lower conveying gas velocity reduces fibrillation of the PTFE powder during the conveyance.

Negative-pressure conveyance reduces PTFE powder leakage into the processing environment of the powder handling system 100 as leak points of the transfer channel 124 draw environmental gas into the system. In one example, the vacuum source 126 generates sufficient negative pressure to achieve a pickup velocity (e.g., minimum velocity required for particle entrainment) of at least 2,500 feet-per-minute (fpm) for an inner dimension (e.g., ID) of the transfer channel 124 of 2 inches. The pickup velocity can be adjusted based on at least PTFE grade (e.g., density, morphology), pipe diameter, gas pressure/density, and solids loading (e.g., mass of PTFE powder per mass conveying gas).

The conveying gas is cooled, e.g., to a temperature below a beta transition temperature of the PTFE powder (e.g., below 19° C.). The conveying gas is a dry gas that is substantially free of water and contaminants. In some examples, the conveying gas is an inert gas.

The transfer channel 124 provides a flow path for the dilute phase PTFE powder from the storage unit 102 to a channel outlet 128. The transfer channel 124 is constructed from one or more substantially straight pipe sections 130, one or more elbows 132, or both. The interior of the transfer channel 124, e.g., the surfaces which contact the PTFE powder dilute phase during handling, have a smooth finish to reduce friction and consequent aggregation of the fine powder. For instance, the connections of the transfer channel 124 are welded and ground to a smooth finish (e.g., such that substantially no weld points or seams are present on the interior surfaces of the transfer channel) to facilitate reduced friction during handling. The number of elbows 132 in the transfer channel 124 is minimized to reduce overall shear and friction of flowing material in the transfer channel 124. The interior of the transfer channel 124 is a non-reactive material, such as stainless steel.

In some implementations, the transfer channel 124 is cooled, e.g., using counterflow cooled pipes or a cooling jacket, to maintain the bulk temperature of the PTFE powder at a reduced temperature compared to atmospheric temperatures. In some examples, the transfer channel 124 is temperature controlled to a temperature below a beta transition temperature of the PTFE powder (e.g., below 19° C.) and above a dew point of the environment. Operation at reduced temperature reduces shear on the PTFE powder, thereby helping to avoid fibrillation. Temperatures significantly lower than the beta transition temperature can be considered to account for the heat that can potentially be generated due friction of gas and friction of the PTFE particles.

In general, the straight pipe sections 130 have a length of at least 10 pipe diameters between pickups and elbows 132 to establish smooth flow. For example, pipe sections 130 having 2-inch ID are at least 20 inches in length. In some implementations, the pipe sections 130 have a length between 10 pipe diameters and 20 pipe diameters.

The elbows 132 are manufactured to reduce friction and shear forces on the PTFE powder in the dilute phase. In some implementations, the elbows 132 have a high radius of curvature, e.g., the radius of curvature is larger than pipe diameter, e.g., R_{c}≥1.5 D, e.g., a long radius elbow (LR Elbow) (e.g., Rc≥5 D, Rc≥10 D). In some implementations, the elbows 132 are manufactured to reduce friction between the inner surfaces of the elbow and the PTFE powder, such as a Gamma Bend manufactured by Coperion (Stuttgart, DE), or the Pellbow Bend from Pelletron Corp. (Lancaster, PA).

In some examples, the transfer channel 124 includes switches, manifolds, or valves (e.g., a diverter valve) 134 to control the flow of the dilute phase PTFE powder through the transfer channel 124.

In the example system of FIG. 1A, a vacuum source 126 is connected to the transfer channel 124 which generates a negative pressure in the inner volume of the transfer channel 124. The outlet 122 enters a flow-permissive state and PTFE is discharged from the storage unit 102. The negative pressure of the inner volume of the transfer channel 124 causes the PTFE powder to enter the dilute phase while being conveyed through the transfer channel 124.

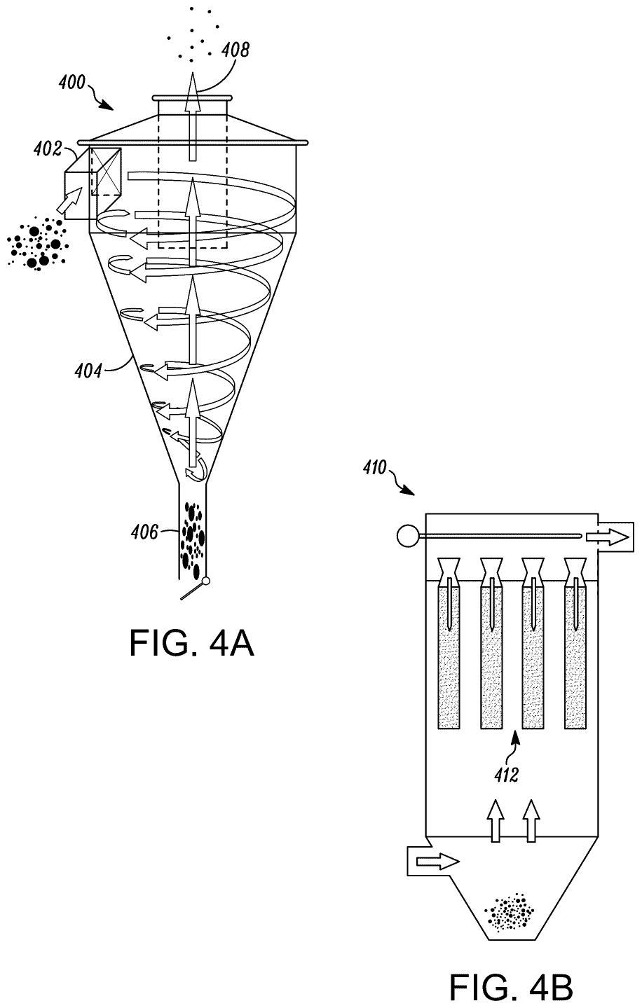

The dilute phase PTFE powder is transported with the carrier gas along the transfer channel 124 to a separator 136. The separator 136 functions to separate the carrier gas from the dilute phase PTFE powder, thereby causing the PTFE powder to enter the dense phase. FIGS. 4A and 4B show example separators which can be used for separator 136. FIG. 4A is a depiction of a cyclone separator 400 which receives the dilute phase PTFE powder through an inlet 402 and subjects the dilute phase to cyclonic motion in the body. The PTFE powder undergoes centripetal motion as the carrier gas follows a circulatory path depicted as the example dashed line. The PTFE particles are transported to the inner surface of the body 404 at which they fall under gravity to an outlet 406. Cyclonic separators are constructed of stainless steel with a smooth surface finish, e.g., a surface finish of 4B or better. The carrier gas is exhausted from an exhaust 408 substantially free of PTFE powder. Cyclonic separators have moderate to high collection efficiency and generally low capital and maintenance costs. In some implementations, cyclonic separators impose a degree of shear on the PTFE powder which can induce fibrillation.

A valve at the outlet 406 of the cyclonic separator prevents the flow of gas into the body of the cyclonic separator and helping to ensure that the conveying gas escapes via the exhaust 408. In some implementations, the outlet 406 includes a flapper valve with an extended spool piece. The flapper valve opens when there is sufficient material inside the spool piece reduces the flow of carrier gas through the spool piece and flapper valve. The flapper valve can be equipped with a level detector to maintain a desired level before discharging material. Implementations utilizing an extended spool piece may include flow promotion devices, such as vibrators, activated when the valve is open to promote flow of the PTFE powder from the outlet 406.

FIG. 4B depicts a bag filter system 410 which separates the PTFE powder from the carrier gas with bag filters 412. Dilute phase PTFE enters the bag filter system 410 and is separated from the carrier gas. The bag filter system 410 is sized such that the superficial filtration velocity (aka Air-to-Cloth Ratio) is maintained below 3 feet-per-minute. The material of the bag filters 412 is selected to be compatible with the carrier gas, PTFE powder, and the temperature of the process. Fabric filters, e.g., non-pleated filters, reduce the compression under which the PTFE powder undergoes during filtration and reduce powder aggregation. Bag filter systems generally have higher collection efficiency than cyclonic separators but are more costly to install and operate. In some implementations, bag filter systems impose compression on the PTFE powder which can induce fibrillation or clumping.

A valve at the outlet of the bag filter system 410 prevents flow of gas into the bag filter system 410. In some implementations, the outlet of the bag filter system 410 includes a flapper valve with an extended spool piece. The flapper valve opens when there is sufficient material inside the spool piece reduces the flow of carrier gas through the spool piece and flapper valve. The flapper valve can be equipped with a level detector to maintain a desired level before discharging material. Implementations utilizing an extended spool piece may include flow promotion devices, such as vibrators, activated when the valve is open to promote flow of the PTFE powder from the outlet.

Bag filter systems can be cleaned, to detach the PTFE powder, using reverse-jet pulsing systems or mechanical shaking. When reverse-jet pulsing is used, chilled compressed gas that is free of moisture and contaminants is used as the jet gas.

In some implementations, multiple separators are employed in series or in parallel, such as multiple of the same type of separator, or both one or more cyclone separators and one or more bag filter systems.

Referring again to FIG. 1, the channel outlet 128 is in fluid connection with the separator 136 and regulates the flow of the PTFE powder out of the transfer channel 124 and the powder handling system 100. In some implementations, the channel outlet 128 includes a mechanical sieve, e.g., a mesh filter, for sieving out or breaking up aggregated PTFE powder. For example, the channel outlet 128 includes a No. 4 mesh (e.g., 4.75 mm openings) to sieve and/or disrupt aggregates. In some implementations, the sieve is vibrated. Sieved aggregates are discarded.

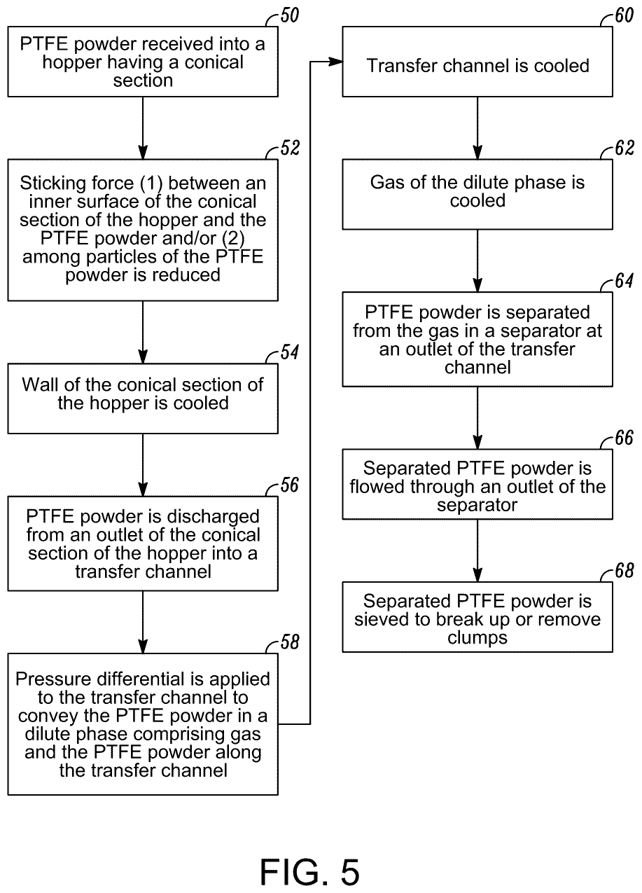

Referring to FIG. 5, in an example method for handling PTFE powder, PTFE powder is received into a hopper (50). The hopper has a conical lower section and a cylindrical upper section. For instance, at least 200 pounds of PTFE powder can be received into the hopper, and less than a threshold amount of PTFE powder that would induce aggregation in itself due to a force exerted by its own weight. The PTFE powder can be received into the hopper from an upstream hopper or from a drum.

A sticking force between an inner surface of the conical section of the hopper and the PTFE powder, or among particles of the PTFE powder, is reduced (52). The sticking force can be reduced by aerating the inner surface of the hopper, e.g., using a cooled, insert aeration gas that is contains substantially no water. The sticking force can be reduced by applying a mechanical vibration to the PTFE powder in the hopper. The sticking force can be reduced by injecting a gas into the PTFE powder in the hopper.

A wall of the conical section of the hopper is cooled (54), e.g., to a temperature that is below a beta transition temperature of the PTFE powder and above a dew point of the environment. For instance, the wall can be cooled using a cooling jacket.

PTFE powder is discharged from an outlet located near a base of the conical section of the hopper into a transfer channel (56).

A pressure differential, such as suction or a positive pressure, is applied to the transfer channel to convey the PTFE powder in a dilute phase comprising a gas and the PTFE powder along the transfer channel (58). For instance, the pressure differential is applied using a variable frequency drive to control a velocity of the dilute phase in the transfer channel, e.g., to generate a pickup velocity of at least 2,500 feet per minute.

The transfer channel is cooled (60), e.g., using a cooling jacket. The gas of the dilute phase is cooled (62) to a temperature that is below a beta transition temperature of the PTFE powder and above a dew point of the environment.

At an outlet of the transfer channel, the PTFE powder is separated from the gas in a separator (64), e.g., in a cyclone separator or a bag filter. The separated PTFE powder is flowed through a discharge valve, such as a flapper valve, at an outlet of the separator (66), and sieved to break up or remove clumps of PTFE powder (68).

The separated PTFE powder has a particle morphology (e.g., size, shape, or both) that is sufficient to be used for compounding with other electrode film components for dry manufacturing of film battery electrodes. For instance, at least some of the separated PTFE powder comprises substantially unfibrillated PTFE agglomerates, e.g., a sufficient quantity of substantially unfibrillated PTFE agglomerates to enable manufacturing of the film battery electrodes.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable subcombination.

A number of implementations have been described. Nevertheless, it will be understood that various modifications may be made without departing from the spirit and scope of the invention. Accordingly, other implementations are within the scope of the following claims.

1. A method for handling polytetrafluoroethylene (PTFE) powder, the method comprising:
receiving PTFE powder into a hopper having a conical section;
reducing a sticking force (1) between an inner surface of the conical section of the hopper and the PTFE powder, (2) among particles of the PTFE powder, or both;
discharging the PTFE powder from an outlet located near a base of the conical section of the hopper into a transfer channel:
applying a pressure differential to the transfer channel to convey the PTFE powder in a dilute phase comprising a gas and the PTFE powder along the transfer channel; and
at an outlet of the transfer channel, separating the PTFE powder from the gas,
in which the separated PTFE powder has a particle morphology that is sufficient for dry manufacturing of film battery electrodes.

2. The method of claim 1, in which at least some of the separated PTFE powder comprises substantially unfibrillated PTFE agglomerates.

3. The method of claim 1, in which the separated PTFE powder comprises a sufficient quantity of substantially unfibrillated PTFE agglomerates to enable manufacturing of the film battery electrodes.

4. The method of claim 1, in which at least 40% by weight of the PTFE powder received into the hopper is separated from the gas for use for manufacturing of the film battery electrodes.

5. The method of claim 1, in which receiving the PTFE powder into the hopper comprises receiving at least 200 pounds of PTFE powder into the hopper.

6. The method of claim 5, in which receiving the PTFE powder into the hopper comprises receiving a volume of PTFE powder that is less than a threshold volume of PTFE powder, in which the threshold volume of PTFE powder is a volume of PTFE powder that, when received into the hopper, undergoes aggregation due to a force exerted by its own weight.

7. The method of claim 1, comprising applying a suction to an inlet channel to convey an initial dilute phase comprising the PTFE powder along the inlet channel and into the hopper.

8. (canceled)

9. (canceled)

10. The method of claim 1, in which the hopper comprises a first hopper, and comprising discharging PTFE powder from an outlet of a second hopper into the transfer channel.

11. (canceled)

12. The method of claim 1, in which reducing a sticking force between the inner surface of the hopper and the PTFE powder comprises aerating the inner surface of the hopper.

13. The method of claim 12, in which aerating the inner surface of the hopper comprises flowing an aeration gas between an outer wall of the conical section of the hopper and a porous inner wall of the conical section of the hopper.

14. The method of claim 13, in which the porous inner wall of the conical section extends from the outlet of the conical section to a position along the inner wall of the conical section where a diameter of the conical section is at least 75% of a maximum diameter of the conical section.

15. The method of claim 13, comprising cooling the aeration gas prior to flowing of the aeration gas.

16. The method of any of claim 13, in which the aeration gas comprises an inert gas.

17. The method of any of claim 13, in which the aeration gas contains substantially no water.

18. The method of claim 1, comprising cooling a wall of the conical section of the hopper.

19. The method of claim 18, comprising cooling the wall of the conical section of the hopper to a temperature below a beta transition temperature of the PTFE powder.

20. The method of claim 18, in which the hopper comprises a cylindrical section connected to the conical section and comprising cooling a wall of the cylindrical section and the wall of the conical section of the hopper.

21. The method of claim 18, in which the conical section of the hopper comprises a cooling jacket disposed on the wall of the conical section, and in which cooling the wall of the conical section comprises flowing a cooling fluid through the cooling jacket.

22. The method of claim 1, comprising providing a layer of cooling gas in the hopper between the PTFE powder and an inlet of the hopper.

23. The method of claim 1, in which a height of the hopper is at least twice as large as a maximum diameter of the conical section of the hopper.

24. (canceled)

25. The method of claim 1, in which the inner surface of the hopper comprises a polished stainless steel, in which the polishing is in a direction of flow of the PTFE powder.

26. The method of claim 1, in which reducing a sticking force between the inner surface of the hopper and the PTFE powder comprises applying a mechanical vibration to the PTFE powder in the hopper.

27. The method of claim 1, in which reducing a sticking force between the inner surface of the hopper and the PTFE power comprises injecting a gas into the PTFE powder in the hopper.

28. The method of claim 1, in which applying a pressure differential to the transfer channel comprises applying a suction to the pressure channel.

29. The method of claim 1, in which applying a pressure differential to the transfer channel comprises applying a positive pressure to the pressure channel.

30. The method of claim 1, in which applying a pressure differential to the transfer channel comprises applying a pressure differential to generate a pickup velocity of at least 2,500 feet per minute.

31. The method claim 1, in which applying a pressure differential to the transfer channel comprises operating a variable frequency drive to apply the pressure differential to the transfer channel.

32. The method of claim 31, comprising operating the variable frequency drive to control a velocity of the dilute phase in the transfer channel.

33. The method of claim 1, comprising cooling the transfer channel.

34. The method of claim 33, in which the transfer channel comprises a jacket, and in which cooling the transfer channel comprises flowing a fluid through the jacket of the transfer channel.

35. The method of claim 1, comprising cooling the gas of the dilute phase.

36. The method of claim 1, in which the gas of the dilute phase comprises an inert gas.

37. The method of claim 1, in which an inner surface of the transfer channel comprises stainless steel.

38. The method of claim 1, in which an inner surface of the transfer channel is free of weld points.

39. The method of claim 1, in which conveying the dilute phase along the transfer channel comprises conveying the dilute phase around an elbow designed to reduce compaction and shear.

40. The method of claim 1, comprising maintaining the gas of the dilute phase at a temperature that is above a dew point of the environment of the transfer channel.

41. The method of claim 1, comprising separating the PTFE powder from the gas in a cyclone separator.

42. The method of claim 41, comprising applying suction to the cyclone separator.

43. (canceled)

44. The method of claim 1, in which separating the PTFE powder from the gas comprises:
separating the PTFE powder from the gas in a separator; and
flowing the PTFE powder through a discharge valve at an outlet of the separator.

45. (canceled)

46. The method of claim 1, comprising separating the PTFE powder from the gas in multiple separators arranged in series or parallel along the transfer channel.

47. The method of claim 46, in which each of the multiple separators has discharge valves that connect to a common receiving vessel.

48. The method of claim 1, comprising sieving the separated PTFE powder using a sieve to break up or remove clumps of material.

49. The method of claim 48, comprising vibrating the sieve.

50. The method of claim 48 or 49, in which the sieve comprises a mesh with openings 2 mm in diameter.

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)
